(19) United States
(12) Patent Application Publication
(10) Pub. No.: US 2002/0133401 A1
(43) Pub. Date: Sep. 19, 2002

(54) Method and system for accumulating coupon values in an account for future redemption

(75) Inventors: Jeffrey R. Mount, Monroe, CT (US); Jay M. Richetelli, Fairfield, CT (US)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: SUPERMARKETS ONLINE, INC., Greenwich, CT (US)

(21) Appl. No.: 09/805,997

(22) Filed: Mar. 15, 2001

(51) Int. Cl. G06F 17/60

(52) U.S. Cl. 705/14

(57) ABSTRACT

A method, system, and computer program product for accumulating coupon values in an account for future redemption is disclosed. A memory stores consumer identifiers and account identifiers such that each consumer identifier maps to one of the account identifiers. Each consumer identifier corresponds to a consumer and each account identifier corresponds to a points account of a consumer. A processor in communication with the memory receives transaction information at a point-of-sale (POS) in response to a transaction between one of the consumers and a retailer. The transaction information includes one of the consumer identifiers and coupon information of unrelated coupons. The processor identifies the consumer's points account from the received one of the consumer identifiers, based on the stored consumer identifiers and the stored account identifiers, converts values of the unrelated coupons to points, and credits the points account of the consumer with the points.

### BACKGROUND OF THE INVENTION

### FIELD OF THE INVENTION

The present invention relates generally to method, system, and computer program product for retail couponing, and more specifically to the use of an account to store redeemable points.

### DISCUSSION OF THE BACKGROUND

Product manufacturers commonly spend great sums of money on coupons as part of their advertising and promotions expenditures. This is even more true of product manufacturers that make consumable goods that are purchased in grocery stores or other popular retail locations. Many consumers eagerly await the receipt of coupons in the newspaper or in the mail so that they can collect the coupons and take them with them the next time that they go grocery shopping. Many more consumers use coupons at least occasionally when they see an offer that is particularly appealing to them. In addition to product manufacturers, service providers and retail stores also participate in coupon promotions by issuing their own coupons or by increasing the value of coupons issued by others.

Typically, even the best coupons result in savings of only a small amount when used individually. Even when many coupons are used at once in a single visit to the store, the total savings resulting from the coupons is usually only a relatively small percentage of the total cost of the goods or services purchased. There are many people who do not participate at all in coupon programs because the perceived benefit of coupons is relatively small. There exist a great deal of people who would use coupons more often if they perceived the benefit of coupons to be larger. Thus, there is a need to encourage more consumers to participate in coupon programs.

Systems for encouraging consumers to participate in coupon programs more frequently are disclosed in U.S. Pat. Nos. 5,471,669; 5,970,480; and 5,991,736, each of which is incorporated herein by reference. However, with these systems, there is no convenient and flexible way of converting coupons of different manufacturers (i.e., unrelated coupons) from a cash value to a common, homogenized value.

### SUMMARY OF THE INVENTION

Consumer identifiers (CIDs) and account identifiers (IDs) are stored such that each CID maps to one of the account IDs. In some embodiments, more than one CID maps to each account ID, and/or the CID is the account ID. Each CID corresponds to a consumer, and each account ID corresponds to a points account of a consumer. When a consumer makes a transaction, a computer receives transaction information that includes the consumer's CID and the value of any coupons that the consumer is redeeming. The coupons may be unrelated, which means that they are from different manufacturers and for different products. The computer then converts the value of the coupons to points, which are credited to the consumer's points account.

Accordingly, the present invention advantageously is able to take any coupon that is normally redeemable in a store, even if the coupons are for different products and manufacturers, and convert all of the coupon values into points that are accumulated and may be redeemed for rewards at a future date. Thus, by permitting points to accumulate before redemption, a consumer is rewarded with a relatively small number of large rewards based on accumulated coupon points rather than with numerous, insignificant discounts.

Further, retailers using the invention are able to aggregate multiple streams of coupons from different national promotions and to deliver them to consumers as retailer loyalty rewards. Thus, the present invention advantageously permits retailers to supplement or replace their chain loyalty marketing expenses with third party (e.g., a product manufacturer) national promotion values that have previously been unavailable to the retailers for use as local marketing funds. As a result, consumers perceive themselves as the benefactors of the chain's loyalty marketing efforts, and the positive branding effects of the national promotion funds inure to the local retailer's franchise.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a computerized system for homogenizing coupon values and storing points in redeemable accounts of consumers, according to an embodiment of the present invention;

FIG. 2A is an exemplary account ID table for linking consumer identifiers (CIDs) to consumers' accounts;

FIG. 2B is transaction table for storing transaction information relating to coupons exercised during different retail transactions, according to one embodiment;

FIG. 2C is a summary table for storing summary information of the transactions for consumers' accounts over a predetermined window of time, according to one embodiment;

FIG. 2D is an account total table for storing the total points accumulated in customers' accounts, according to one embodiment;

FIG. 3 is a flowchart for explaining how coupons are converted to points which are stored in a redeemable account, according to an embodiment of the invention;

FIG. 4 is a flowchart for explaining how coupon values are converted to a homogenous store of points, which is kept in a summary table in one embodiment;

FIG. 5 is a flowchart for explaining how a consumer redeems points stored in his or her account, according to one embodiment; and

FIG. 6 is a schematic illustration of a computer system programmed to perform one or more of the special purchase functions of the present invention.

### DESCRIPTION OF THE PREFERRED EMBODIMENTS

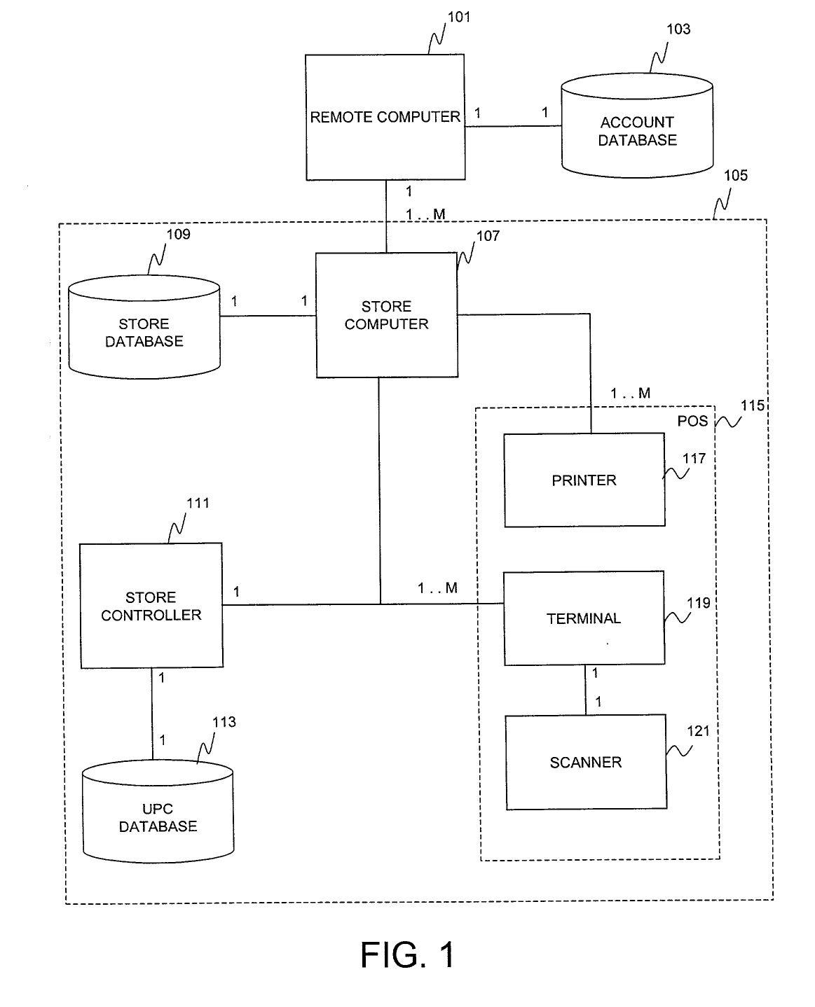

Referring now to the drawings, wherein like reference numerals designate identical or corresponding parts throughout the several views, and more particularly to FIG. 1 thereof, there is shown a computerized system for homogenizing coupon values and storing points (or coupon points) in redeemable accounts of consumers. The system of FIG. 1 includes a remote computer 101, an account database 103, and one or more retail stores 105. Each retail store 105 includes one or more of the following: a store computer 107, a store database 109, a store controller 111, a UPC database 113, and a point of sale (POS) 115. Preferably, each POS includes a printer 117, a terminal 119, and a scanner 121.

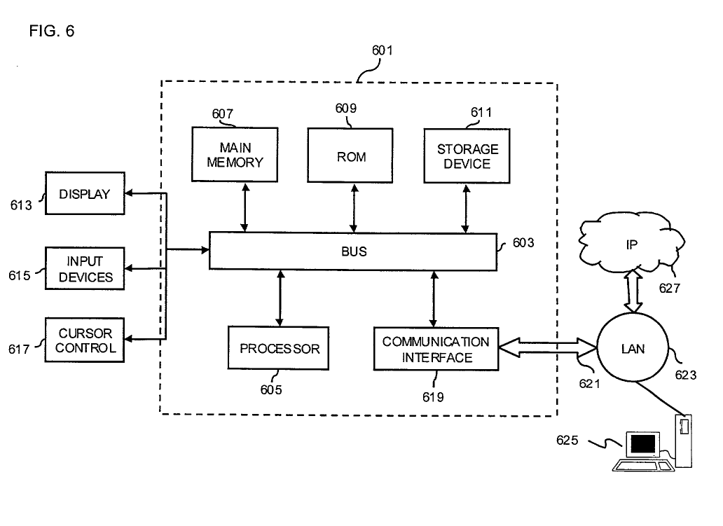

The remote computer 101 is any suitable workstation, server, or other device, such as the computer system 601 of FIG. 6, for communicating with the store computer 107 and for storing information in and retrieving information from the account database 103. According to one embodiment, the remote computer 101 also communicates directly or indirectly with home computers of consumers (via the Internet, for example) so that consumers can register with the system online. In a preferred embodiment, the remote computer 101 and the store computer 107 communicate over a standard telephony network; however, any suitable communications medium may be used.

The remote computer 101 may be operated by a marketing company, the retail store 105, a product manufacturer, or any other entity. Remote computer 101 and the store computer 107 may also be combined into a single computer located in the store 105 or remotely, for example.

The account database 103 is a file that includes records containing information for keeping track of consumers' points accounts and generating new points accounts when consumers register with the system. This information may include consumer identifiers (CIDs), account totals, and account identifiers (IDs), for example. Records in the account database 103 contain fields together with a set of operations for searching, sorting, recombining, and other database functions. The account database 103 may be implemented as two or more databases, if desired, and may be an aggregate of several databases storing points account data obtained from different sources such as the Internet, grocery stores, hardware stores, pet superstores, video stores, and restaurants, for example. One or more of U.S. Pat. Nos. 5,832,457; 5,649,114; 5,430,644; and 5,592,560 describe techniques for collecting consumer information and for storing such information in databases such as the account database 103, the store database 109, and the UPC database 113, for example. U.S. Pat. Nos. 5,832,457; 5,649,114; 5,430,644; and 5,592,560 are incorporated herein by reference. Additionally, techniques for collecting consumer purchase information and for storing such information in databases, such as the account database 103 and the UPC database 113, are described in other patents owned by Catalina Marketing, Catalina Marketing International, and/or Supermarkets Online. Each patent owned by Catalina Marketing, Catalina Marketing International, and/or Supermarkets Online is incorporated herein by reference.

The retail store 105 is generically referred to as a retail location and is a place where goods are kept for retail sale to consumers. As noted above, many retail stores 105 may be connected to the remote computer 101. Examples of retail stores include grocery stores, drugstores, gas stations, bookstores, clothing stores, and hardware stores.

The store computer 107 may be implemented using the computer system 601 of FIG. 6, for example, or any other suitable PC, workstation, server, or device. The store computer 107 communicates with the remote computer 101, stores and retrieves information in the store database 109, monitors data transmitted between the terminal 119 and the store controller 111 (i.e., transaction data), and controls the printer 117.

The store database 109 is a file that includes records containing information for managing points accounts of consumers in accordance with the present invention. The records in the store database 109 contain fields for associating consumers with account IDs, coupon values, transaction dates, and coupon points. The store database 109 also includes operations for searching, sorting, recombining, and other database functions. The store database 109 may be implemented as two or more databases, if desired. Periodically, (e.g., daily or weekly) sales transaction information stored in the store database 109 is retrieved by the store computer 107 and sent to the remote computer 101, which uses the information to update the points accounts of consumers stored in the account database 103.

The store controller 111 is any computer or device for communicating with the terminal 119 and for using information stored in the UPC database 113 to carry out transactions at the POS 115. An exemplary store controller 111 is described in U.S. Pat. No. 5,173,851, which is incorporated herein by reference.

The UPC database 113 is a file that includes records containing information for carrying out transactions at the POS 115 by scanning bar codes printed on purchased items. The records in the UPC database 113 contain fields for associating bar codes with products and their corresponding prices. Also in the UPC database 113 are records containing information for recognizing barcode information on coupons so that coupons can be scanned, verified, and automatically processed. The UPC database 113 also includes operations for searching, sorting, recombining, and other database functions, and may be implemented as two or more databases, if desired. In alternative embodiments, JAN and/or EAN codes may be used in place of, or in combination with, the UPC codes.

The retail store 105 includes one or more POSs 115. The printer 117 at the POS 105 receives printing instructions from the store computer 107. According to an embodiment of the present invention, coupons, promotions, and redemption certificates are printed by the printer 117 in response to receiving commands from the store computer 107. The terminal 119 may be implemented as a standard cash register and may include, or be connected to, a screen, card reader, and/or numeric keypad, for example. The terminal 119 communicates with the store controller 111 and the scanner 121. The scanner 121 may be implemented as any conventional scanning device for reading product information such as an item code (e.g., UPC, EAN, or JAN) from bar codes or other indicia on products and coupons. Information read by the scanner 121 is transmitted to the store controller 111 via the terminal 119. The store controller 111, uses the scanned information and the information stored in the UPC database 113 to determine information of the transaction including the SKU, price, quantity, value of coupons, and date and time of the transaction, for example.

If there are multiple POSs 115 within the retail store 105, then each terminal 119 is preferably arranged on a loop with the store controller 111. The store computer 107 is located in front of the store controller 111 on the loop so that information transmitted back and forth between the terminals 119 and the store controller 111 is monitored by the store computer 107.

It is to be understood that the system in FIG. 1 is for exemplary purposes only, as many variations of the specific hardware and software used to implement the present invention will be readily apparent to one having ordinary skill in the art. For example, the functionality of the store computer 107 and the store controller 111 may be combined in a single device. An another example, the store database 109 and the UPC database 113 maybe combined into a single database. These implementations and other implementations of retail computer systems are described in greater detail in one or more of U.S. Pat. Nos. 4,723,212; 4,910,672; 5,612,868; and 6,026,370, each of which is incorporated herein by reference. To implement these variations as well as other variations, a single computer (e.g., the computer system 601 of FIG. 6) may be programmed to perform the special purpose functions of two or more of any of the devices shown in FIG. 1. On the other hand, two or more programmed computers may be substituted for any one of the devices shown in FIG. 1. Principles and advantages of distributed processing, such as redundancy and replication, may also be implemented as desired to increase the robustness and performance of the system, for example.

The present invention stores information relating to various consumers who shop at the retail store 105, the purchase information of those consumers, points accounts of the consumers, and identifying information of the consumers, for example. This information is stored in one or more memories such as a hard disk, optical disc, magneto-optical disk, and/or RAM, for example. One or more databases, such as the account database 103 and the store database 109, may store the information used to implement the present invention. The databases are organized using data structures (e.g., records, tables, arrays, fields, graphs, trees, and/or lists) contained in one or more memories, such as the memories listed above or any of the storage devices listed below in the discussion of FIG. 6, for example.

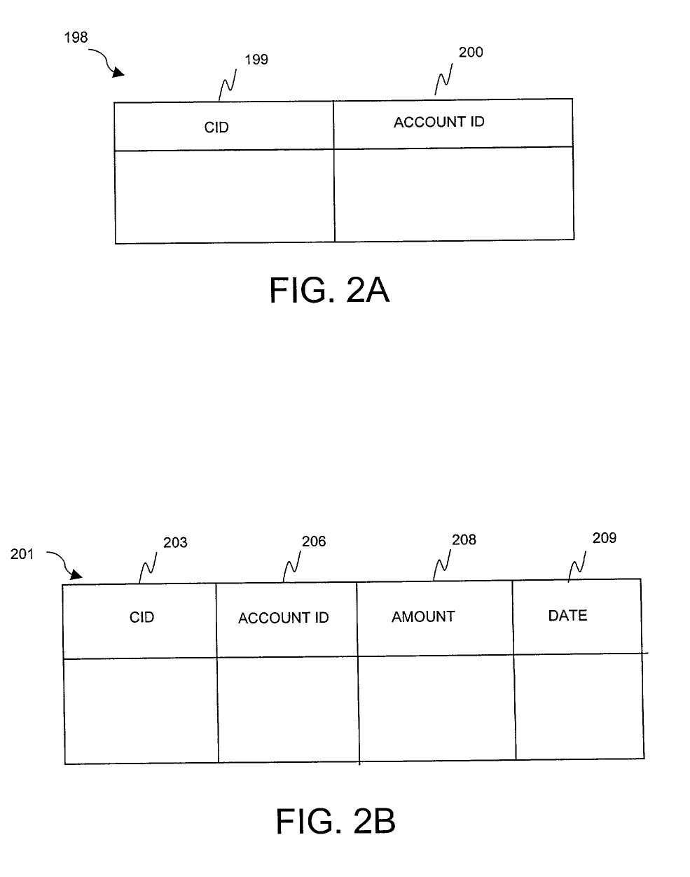

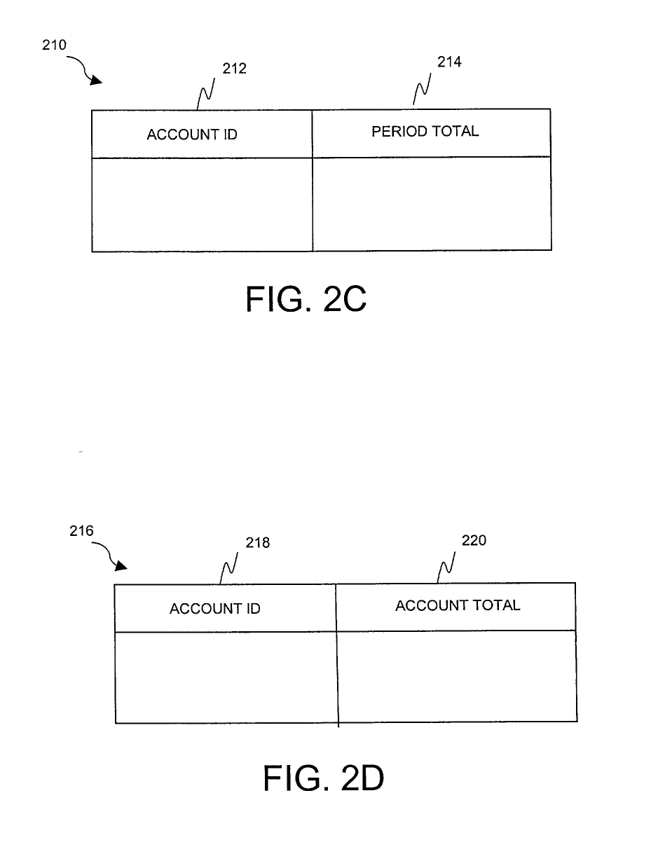

FIG. 2A, 2B, 2C, and 2D depict data structures used for implementing a system for converting coupon values into coupon points and storing those points in separate accounts for future redemption, according to an embodiment of the present invention. The data structures are depicted in a relational format, using tables, whereby information stored in one column (i.e., field) of a table is mapped or linked to information stored in the same row (i.e., record) across the other column(s) of the table. These data structures are used by the remote computer 101 and/or the store computer 107 to manage customers' points accounts and to deliver offers, promotions, and rewards to consumers in accordance with the present invention. The data structures shown in FIGS. 2A, 2B, 2C, and 2D are stored in the account database 103, the store database 109, and/or any other suitable storage device(s) or medium(s).

FIG. 2A is an account ID table 198 that maps one or more customer identifiers (CIDs) to an account ID. As shown in FIG. 2A, CIDs are stored in the field 199 and account IDs are stored in the field 200, for example. In one embodiment, the account ID is the CID and the field 199 is eliminated. However, for the convenience of the customer, it is often preferable to link multiple CIDs to a single account ID of the consumer, in which case, the account IDs may appear in the field 200 more than once. The account IDs identify points accounts of customers. The points accounts accumulate coupon points, and consumers exchange (i.e., redeem) points in their coupon accounts for rewards. The rewards preferably have varying costs. For example, a free steak may cost the consumer twice as many points as three gallons of gasoline.

A CID is any identifier that is scanned, read, or otherwise entered into a computer or terminal to identify a consumer. As used in this context, the term “consumer” includes households and/or other groups of people that use the same CID to identify themselves. Each consumer may have multiple CIDs. Preferably, the CID is represented as a bar code so that it can be quickly scanned at checkout by the scanner 117, although any other type of machine readable or non-machine readable implementations for storing or displaying identifications may be used, including magnetic strips, memory chips, and smart cards. Examples of CIDs include credit card numbers, debit card numbers, social security card numbers, driver's license numbers, checking account numbers, street addresses, names, e-mail addresses, telephone numbers, frequent consumer card numbers, shopper card identifications (SCIDs), or shopper loyalty card numbers issued by the retail store 105, although any other suitable form of identification may be used. For example, a CID may be a cookie stored on the consumer's computer 123 and that identifies the consumer's computer or Web browser software. As used herein, a “cookie” is any block of data that includes identifying information (i.e., a cookie ID) for identifying a consumer's computer 123 or Web browser software to a server or remote computer (e.g., remote computer 101).

FIG. 2B is a transaction table 201 that includes a field 203 for storing consumer CIDs, a field 206 for storing account IDs, a field 208 for storing total coupon points for a single transaction, and a field 209 for storing transaction dates. The transaction table 201 is stored in the store database 109 in one embodiment and is used to keep coupon information of each transaction of consumers at the store 105. For example, if a consumer a purchase and uses a coupon, the consumer's CID is stored in the field 203, the consumer's account ID is stored in the field 206, the total coupon points for the transaction is stored in the field 208 and the date of the transaction is stored in the field 209. In alternative embodiments, the transaction table 201 (as well as any of the other tables in FIGS. 2A, 2C, and 2D) include additional fields for storing additional information and/or omit fields that may be added to other tables or are not required in a particular situation. For example, the field 206 could be eliminated if the remote computer 101 rather than the store computer 107 determines which points accounts are associated with CIDs (using the account ID table 198, for example).

FIG. 2C is a summary table 210 for storing summary information of consumer's coupon points accumulated over a predetermined time period (e.g., daily, weekly, monthly). The summary table 210 includes a field 212 for storing consumer's account IDs and a field 214 for storing the total coupon points earned by consumers during the predetermined time frame. Thus, each record in the summary table 210 identifies the points account of the consumer with the field 212 and the total points earned by that consumer during the predetermined time period in the field 214. The summary table 210 is generated by the store computer 107 based on the account ID table 198 stored in the store database 109.

FIG. 2D is an account total table 216 for storing the total coupon points in each points account. The account total table 216 includes a field 218 for storing account IDs and a field 220 for storing account totals. Thus, each record in the account total table 216 identifies a points account with the account ID in the field 218 and the total coupon points in the account with the field 220.

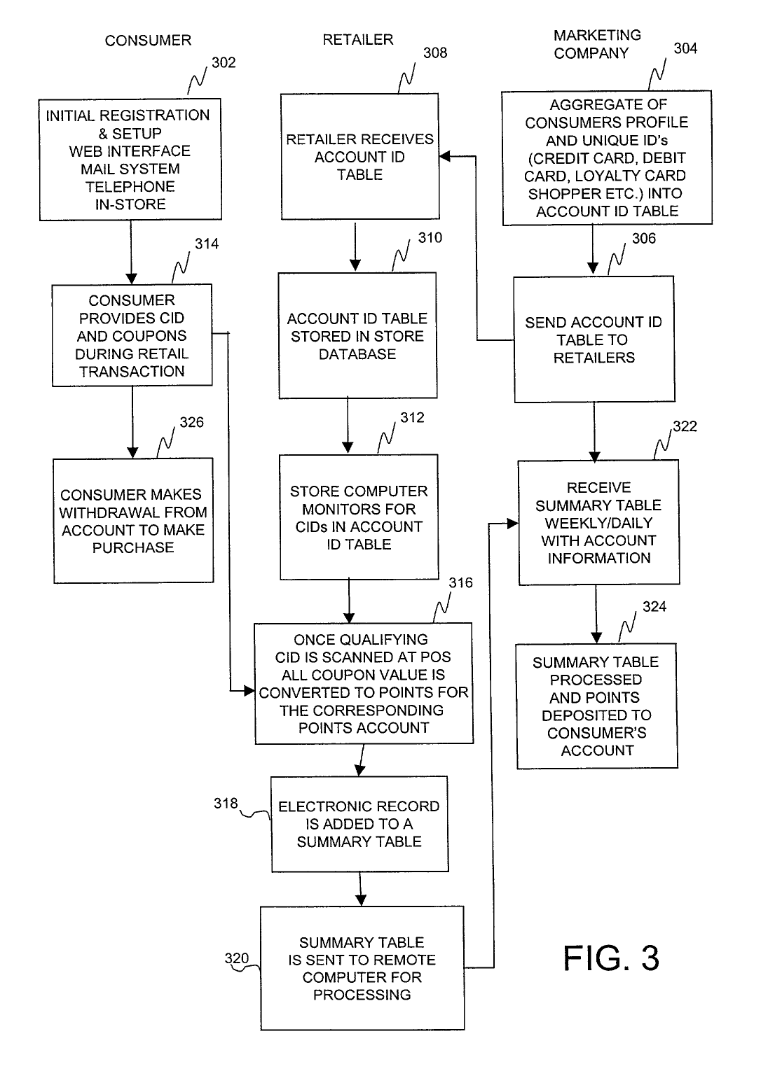

FIG. 3 is a flowchart for explaining how points accounts are generated, managed, and redeemed according to one embodiment of the invention. In step 302 a consumer registers with the system by providing one or more CIDs. Alternatively, the consumer is assigned a CID during the registration step 302. Consumers may register with the system of FIG. 1 in any number of ways including a World Wide Web interface provided by a Web page hosted by a server or other computer, such as the remote computer 101. Also, consumers may register through the mail by filling out a questionnaire, over the telephone, or in the store, for example.

In step 304 the remote computer 101 receives the registration information provided in step 302 and generates a points account and an account ID that uniquely identifies the points account. The new account ID as well as any CIDs provided by the consumer or generated for the consumer are stored as new record(s) in the account ID table 198. If the CID is also generated by the remote computer 101, then the CID is generated in step 304 and provided back to the consumer. This may include issuing a card that uniquely identifies the consumer with a magnetic strip or barcode for example. In one embodiment, the account ID is the same as the CID. However, consumers may have multiple CIDs that they wish to use at various stores or retail locations or on the Internet. In this case, each of the consumer's CIDs are linked with the consumer's account ID. Thus, in step 304 the remote computer 101 creates a list of CIDs with each CID being linked to the account ID of the corresponding consumer. It should be noted that the fUnctionality of the remote computer 101 may be distributed across several computers for a efficiency reasons. For example, one remote computer could receive registration information over the Internet, another remote computer could receive registration information provided by mail-in registration forms or in-store questionnaires, and a third remote computer in communication with the other remote computers could combine all of the registration information to generate account IDs and link CIDs to the account IDs in the account ID table 198.

In step 306 the remote computer 101 sends the account ID table 198 to one or more retail stores 105. In step 308 the store computer 107 receives the account ID table 198 sent from the remote computer 101 in step 306. The table 198 or any other suitable file with the account IDs and CIDs may be sent from the remote computer 101 to the store computer 107 over any suitable transmission media, including file transfer protocol, e-mail, bulletin board services, and/or magnetic tape, for example.

In step 310, the store computer 107 stores the account ID table 198 in the store database 109. If the table 198 is not sent directly to the store computer 107 and stored in the store database 109, then the retailer loads the table 198 into the store database 109. Alternatively, in step 310 the file is loaded into the UPC database 113 and the store controller 111 performs the functions of the store computer 107 so that the store database 109 and the store computer 107 are omitted from the system.

In step 312 the store computer continuously monitors the loop between the POS 115 and the store controller 111 for CIDs in the account ID table 201. In step 314 a consumer enters the store 105 and presents his or her CID during a retail transaction in which he or she also exercises one or more coupons which may be from different manufacturers and/or for different products.

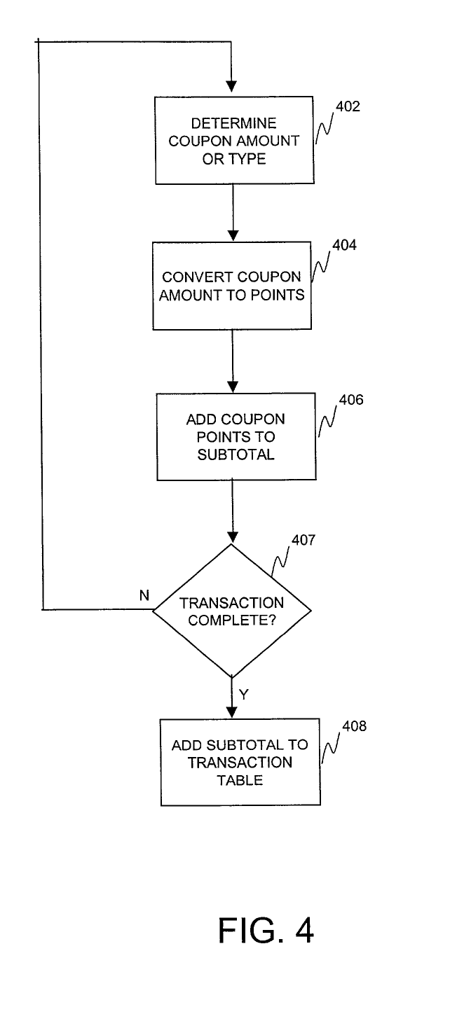

In step 316, a CID that is present in the field 203 of the account ID table 201 is entered into the terminal 119 via the scanner 121, or manually entered into the terminal 119 or a card swipe coupled to the terminal 119, for example. The store computer 107 sees the CID as it is transmitted from the terminal 119 to the store controller 111 and checks the store database 109 to determine whether the CID is in the field 199 of the account ID table 198. In this example, the CID is in the account ID table 198 so the store computer 107 converts all of the coupon values to points and totals them in the transaction table 201. The store computer 107 also creates a new record in the transaction table 201. The new record includes the consumer's CID in the field 203, the consumer's account ID in the field 206 (as determined from the account ID table 198), the total coupon points for the transaction in the field 208, and the date and time of the transaction in the field 209. Step 316 is described in further detail below with reference to FIG. 4.

In step 318, the information in the record of the transaction generated in step 316 is used to update the summary table 210. The summary table may be updated instantly (in which case the transaction table 201 may be eliminated) or periodically, such as every night after the store closes or every 15 minutes, for example. The summary table is updated by adding the points total in the field 208 to the period total in the field 214 for the same account ID. In other words, when the summary table 210 is updated, the store computer 107 adds the coupon points in the field 208 to the period total for the same account in the field 212.

In step 320 the summary table 210 is sent to the remote computer 101 for processing, and in the store database 109, period totals in the field 212 are reset to zero. In step 322 the remote computer 101 receives the summary table 210, which includes the period total for each points account. Alternatively, the summary table 210 may also include information that identifies the particular coupons exercised by the consumer so that the retailer can be reimbursed for the value of the coupons by the entity issuing the coupons. Then, in step 324 the remote computer processes the summary table 210 and adds the period total for each points account in the summary table 210 to the account total in the field 220 of the account total table 216 for the corresponding points account identified in the field 218.

FIG. 4 is a flowchart for explaining in greater detail step 316. In step 402 the store computer 107 determines the cash value of the coupon or the coupon type. From this determination, in step 404 the store computer 107 converts the coupon value into coupon points. For example, a coupon worth 30 cents off may be converted to 30 points, and/or all coupons worth over a dollar off are converted to 200 points. Coupon points may also be awarded based on the type of coupon. For example, all coupons for brand X might receive an extra five points or every coupon used on a certain date receives an extra five points, depending on how the program is run. In another embodiment, each coupon is awarded a single point, regardless of the value of the coupon. Thus, points may be awarded on any basis so that different promotional programs are tailored to fit virtually any situation.

In step 406 the coupon points determined in step 404 are added to a subtotal of coupon points for the transaction. Then, in step 407 the store computer 107 determines whether the current transaction is complete yet. If the transaction is not complete, then the store computer 107 continues to determine coupon points and add the coupon points to the subtotal in steps 402, 404, and 406. If the transaction is complete, then in step 408 the subtotal of coupon points is added to the field 208 for the record of that transaction in the transaction table 201.

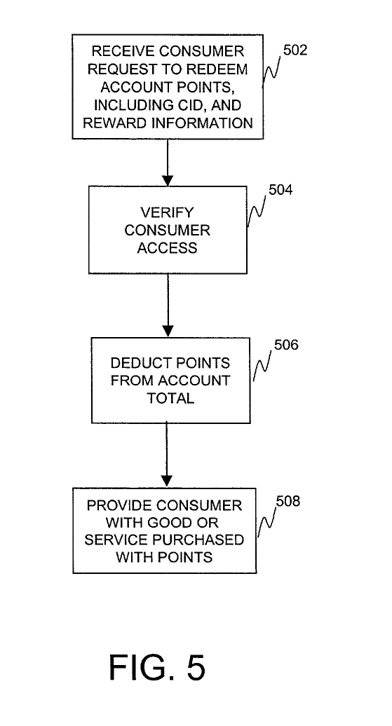

FIG. 5 is a flowchart for explaining how a consumer uses coupon points in his or her points account to purchase rewards. In step 502 the remote computer 101 receives a consumer request to redeem account points for a reward. The consumer may redeem account points through the mail, over the Internet, by telephone, or in the store, for example. In one embodiment, the consumer indicates that he or she wishes to redeem account points and provides a CID that is valid for the consumer's points account. Step 504 of the remote computer 101 checks the account ID table 198 in the account database 103 to verify that a points account exists for the CID provided by the consumer. Alternatively or in addition, a consumer may be required to provide a personal identification (PIN) or other code. Once the consumer's CID is verified, the remote computer 101 deducts the amount of points that the reward costs from the points account total in the field 220 that corresponds to the consumer's points account in the account total table 216. Then, in step 508 the remote computer 101 provides a consumer with the reward that the consumer purchased with the coupon points. In one embodiment, the reward is a mail-in certificate for a prize (e.g., a free steak, a free six pack of brand X cola, a backpack, or a quart of oil) that is printed at the printer 117 when the consumer is at the POS 115 or a kiosk within the store 105. The certificate may be mailed in to an entity identified on the certificate in exchange for a prize. The certificate may also contain other information for obtaining the prize. For example, the consumer may be provided with an identification number on the certificate that the consumer provides over the telephone in order to have the prize mailed to the consumer. Alternatively, the consumer is provided with a prize in the store 105, such as a free one topping pizza from brand Z or a razor scooter, for example.

Another redemption technique that is particularly beneficial for enhancing loyalty to a retailer (or retail chain) is the issuance of gift certificates for a particular store or chain of stores . Electronic gift certificates are generated by the remote computer 101 automatically or in response to a request initiated by a consumer at the POS 115, over the telephone, or at the consumer's home computer or any other computer. The gift certificates may be issued electronically, based on information (e.g., e-mail address) provided by the consumer during registration (FIG. 3, step 302). Alternatively, the gift certificates are printed in the store 105 at printer 117 in response to the store computer 107 recognizing the consumer's CID at POS 115 via scanner 121 or a magnetic card reader, for example.

The gift certificate is intentionally or automatically redeemed by the consumer (depending on the preference of the consumer indicated during registration and/or the configuration of the store computer 107) when the store computer 107 recognizes the consumer's CID at POS 115. When the gift certificate is used or redeemed, the amount of the gift certificate is deducted from the consumer's total purchase. If the amount of the gift certificate exceeds the purchase total, then the consumer may or may not receive the balance of the gift certificate in cash, depending on the configuration of the store computer 107, which is based on the particular promotion being run. If no cash is received by the computer, then the consumer's coupon points account may be recredited with coupon points for the unused portion of the gift certificate.

All or a portion of the invention may be conveniently implemented using conventional general purpose computers or microprocessors programmed according to the teachings of the present invention, as will be apparent to those skilled in the computer art. Appropriate software can be readily prepared by programmers of ordinary skill based on the teachings of the present disclosure, as will be apparent to those skilled in the software art.

FIG. 6 illustrates a computer system 601 upon which an embodiment according to the present invention may be implemented. Computer system 601 includes a bus 603 or other communication mechanism for communicating information, and a processor 605 coupled with bus 603 for processing the information. Computer system 601 also includes a main memory 607, such as a random access memory (RAM) or other dynamic storage device (e.g., dynamic RAM (DRAM), static RAM (SRAM), synchronous DRAM (SDRAM), flash RAM), coupled to bus 603 for storing information and instructions to be executed by processor 605. In addition, main memory 607 may be used for storing temporary variables or other intermediate information during execution of instructions to be executed by processor 605. Computer system 601 further includes a read only memory (ROM) 609 or other static storage device (e.g., programmable ROM (PROM), erasable PROM (EPROM), and electrically erasable PROM (EEPROM)) coupled to bus 603 for storing static information and instructions for processor 605. A storage device 611, such as a magnetic disk or optical disc, is provided and coupled to bus 603 for storing information and instructions.

The computer system 601 may also include special purpose logic devices (e.g., application specific integrated circuits (ASICs)) or configurable logic devices (e.g., generic array of logic (GAL) or reprogrammable field programmable gate arrays (FPGAs)). Other removable media devices (e.g., a compact disc, a tape, and a removable magneto-optical media) or fixed, high density media drives, may be added to the computer system 601 using an appropriate device bus (e.g., a small computer system interface (SCSI) bus, an enhanced integrated device electronics (IDE) bus, or an ultra-direct memory access (DMA) bus). The computer system 601 may additionally include a compact disc reader, a compact disc reader-writer unit, or a compact disc juke box, each of which may be connected to the same device bus or another device bus.

Computer system 601 may be coupled via bus 603 to a display 613, such as a cathode ray tube (CRT), for displaying information to a computer user. The display 613 may be controlled by a display or graphics card. The computer system includes input devices, such as a keyboard 615 and a cursor control 617, for communicating information and command selections to processor 605. The cursor control 617, for example, is a mouse, a trackball, or cursor direction keys for communicating direction information and command selections to processor 605 and for controlling cursor movement on the display 613. In addition, a printer may provide printed listings of the data structures shown in FIGS. 2A, 2B, 2C, and 2D or any other data stored and/or generated by the computer system 601.

The computer system 601 performs a portion or all of the processing steps of the invention in response to processor 605 executing one or more sequences of one or more instructions contained in a memory, such as the main memory 607. Such instructions may be read into the main memory 607 from another computer-readable medium, such as storage device 611. One or more processors in a multi-processing arrangement may also be employed to execute the sequences of instructions contained in main memory 607. In alternative embodiments, hard-wired circuitry may be used in place of or in combination with software instructions. Thus, embodiments are not limited to any specific combination of hardware circuitry and software.

As stated above, the system 601 includes at least one computer readable medium or memory programmed according to the teachings of the invention and for containing data structures, tables, records, or other data described herein. Stored on any one or on a combination of computer readable media, the present invention includes software for controlling the computer system 601, for driving a device or devices for implementing the invention, and for enabling the computer system 601 to interact with a human user, e.g., a consumer. Such software may include, but is not limited to, device drivers, operating systems, development tools, and applications software. Such computer readable media further includes the computer program product of the present invention for performing all or a portion (if processing is distributed) of the processing performed in implementing the invention.

The computer code devices of the present invention may be any interpreted or executable code mechanism, including but not limited to scripts, interpreters, dynamic link libraries, Java classes, and complete executable programs. Moreover, parts of the processing of the present invention may be distributed for better performance, reliability, and/or cost.

The term “computer readable medium” as used herein refers to any medium that participates in providing instructions to processor 605 for execution. A computer readable medium may take many forms, including but not limited to, non-volatile media, volatile media, and transmission media. Non-volatile media includes, for example, optical discs, magnetic disks, and magneto-optical disks, such as storage device 611. Volatile media includes dynamic memory, such as main memory 607. Transmission media includes coaxial cables, copper wire and fiber optics, including the wires that comprise bus 603. Transmission media also may also take the form of acoustic or light waves, such as those generated during radio wave and infrared data communications.

Common forms of computer readable media include, for example, hard disks, floppy disks, tape, magneto-optical disks, PROMs (EPROM, EEPROM, Flash EPROM), DRAM, SRAM, SDRAM, or any other magnetic medium, compact discs (e.g., CD-ROM), digital versatile discs (DVDs), or any other optical medium, punch cards, paper tape, or other physical medium with patterns of holes, a carrier wave (described below), or any other medium from which a computer can read.

Various forms of computer readable media may be involved in carrying out one or more sequences of one or more instructions to processor 605 for execution. For example, the instructions may initially be carried on a magnetic disk of a remote computer. The remote computer can load the instructions for implementing all or a portion of the present invention remotely into a dynamic memory and send the instructions over a telephone line using a modem. A modem local to computer system 601 may receive the data on the telephone line and use an infrared transmitter to convert the data to an infrared signal. An infrared detector coupled to bus 603 can receive the data carried in the infrared signal and place the data on bus 603. Bus 603 carries the data to main memory 607, from which processor 605 retrieves and executes the instructions. The instructions received by main memory 607 may optionally be stored on storage device 611 either before or after execution by processor 605.

Computer system 601 also includes a communication interface 619 coupled to bus 603. Communication interface 619 provides a two-way data communication coupling to a network link 621 that is connected to a local network (e.g., LAN 623). For example, communication interface 619 may be a network interface card to attach to any packet switched local area network (LAN). As another example, communication interface 619 may be an asymmetrical digital subscriber line (ADSL) card, an integrated services digital network (ISDN) card or a modem to provide a data communication connection to a corresponding type of telephone line. Wireless links may also be implemented. In any such implementation, communication interface 619 sends and receives electrical, electromagnetic, or optical signals that carry digital data streams representing various types of information.

Network link 621 typically provides data communication through one or more networks to other data devices. For example, network link 621 may provide a connection through LAN 623 to a remote computer 625 or to data equipment operated by a service provider, which provides data communication services through an IP (Internet Protocol) network 627 (e.g., the Internet 121). LAN 623 and IP network 627 both use electrical, electromagnetic, or optical signals that carry digital data streams. The signals through the various networks and the signals on network link 621 and through communication interface 619, which carry the digital data to and from computer system 601, are exemplary forms of carrier waves transporting the information. Computer system 601 can transmit notifications and receive data, including program code, through the network(s), network link 621 and communication interface 619.

Obviously, numerous modifications and variations of the present invention are possible in light of the above teachings. It is therefore to be understood that within the scope of the appended claims, the invention may be practiced otherwise than as specifically described herein.

1. A computer-implemented method comprising:
storing consumer identifiers and account identifiers such that each consumer identifier maps to one of the account identifiers, each consumer identifier corresponding to a consumer and each account identifier corresponding to a points account of a consumer;
receiving transaction information at a point-of-sale (POS) in response to a transaction between one of the consumers and a retailer, the transaction information including one of the consumer identifiers and coupon information of unrelated coupons;
identifying the consumer's points account from the received one of the consumer identifiers, based on the stored consumer identifiers and the stored account identifiers;
converting values of the unrelated coupons to points; and
crediting the points account of the consumer with the points.

2. The method of claim 1, wherein the POS is located in a retail store.

3. The method of claim 1, wherein the transaction is conducted over the Internet and the POS is a computer of the retailer.

4. The method of claim 1, further comprising:
repeating the steps of receiving, identifying, converting, and crediting; and
accumulating points of each transaction in the points account of the consumer.

5. The method of claim 1, further comprising receiving registration information of the consumer prior to the step of storing, the registration information including the consumer identifier that corresponds to the consumer.

6. The method of claim 5, further comprising:
generating the account identifier corresponding to the points account of the consumer; and
linking the account identifier with the consumer identifier received with the registration information.

7. The method of claim 1, further comprising:
receiving redemption information of the consumer, the redemption information including the consumer identifier that corresponds to the consumer and reward information identifying a reward having a points value;
deducting from the consumer's points account an amount corresponding to the points value of the reward; and
providing the consumer with the reward.

8. The method of claim 1, wherein the step of receiving transaction information comprises scanning the unrelated coupons and the consumer identifier.

9. The method of claim 1, wherein the step of converting comprises assigning a value of one point to each coupon.

10. A computer readable medium containing program instructions for execution on a computer system, which when executed by the computer system, cause the computer system to perform the steps in the method recited in any one of claims 1 through 9.

11. A system comprising:
a memory having embodied therein information of consumer identifiers and account identifiers such that each consumer identifier maps to one of the account identifiers, the consumer identifiers corresponding to consumers and the account identifiers corresponding to points accounts of the consumers;
a processor in communication with the memory and configured to:
receive transaction information at a point-of-sale (POS) in response to a transaction between one of the consumers and a retailer, the transaction information including one of the consumer identifiers and coupon information of unrelated coupons;
identify the consumer's points account from the received one of the consumer identifiers, based on the stored consumer identifiers and the stored account identifiers;
convert values of the unrelated coupons to points; and
credit the points account of the consumer with the points.

12. The system of claim 11, wherein the POS is located in a retail store.

13. The system of claim 11, wherein the transaction is conducted over the Internet and the POS is a computer of the retailer.

14. The system of claim 11, wherein the processor is further configured to accumulate in the consumer's points account points of subsequent transactions of the consumer.

15. The system of claim 11, further comprising a remote computer in communication with the processor and configured to receive registration information of consumers, the registration information including the consumer identifiers of the consumers.

16. The system of claim 15, wherein the remote computer is further configured to generate the account identifiers and to link the account identifiers with the corresponding consumer identifiers received with the registration information.

17. The system of claim 11, further comprising a remote computer in communication with the processor and configured to:
receive redemption information of the consumer, the redemption information including the consumer identifier that corresponds to the consumer and reward information identifying a reward having a points value;
deduct from the consumer's points account an amount corresponding to the points value of the reward; and
provide the consumer with the reward.

18. The system of claim 11, further comprising:
a scanner in communication with the processor and configured to scan the unrelated coupons and the consumer identifier;
a terminal in communication with the scanner; and
a controller in communication with the terminal.

19. A system comprising:
means for storing consumer identifiers and account identifiers such that each consumer identifier maps to one of the account identifiers, each consumer identifier corresponding to a consumer and each account identifier corresponding to a points account of a consumer;
means for receiving transaction information at a point-of-sale (POS) in response to a transaction between one of the consumers and a retailer, the transaction information including one of the consumer identifiers and coupon information of unrelated coupons;
means for identifying the consumer's points account from the received one of the consumer identifiers, based on the stored consumer identifiers and the stored account identifiers;
means for converting values of the unrelated coupons to points; and
means for crediting the points account of the consumer with the points.

20. The system of claim 19, wherein the POS is located in a retail store.

21. The system of claim 19, wherein the transaction is conducted over the Internet and the POS is a computer of the retailer.

22. The system of claim 19, further comprising:
means for repeating the steps of receiving, identifying, converting, and crediting; and means for accumulating points of each transaction in the points account of the consumer.

23. The system of claim 19, further comprising means for receiving registration information of the consumer, the registration information including the consumer identifier that corresponds to the consumer.

24. The system of claim 23, further comprising:
means for generating the account identifier corresponding to the points account of the consumer; and
means for linking the account identifier with the consumer identifier received with the registration information.

25. The system of claim 19, further comprising:
means for receiving redemption information of the consumer, the redemption information including the consumer identifier that corresponds to the consumer and a reward information identifying a reward having a points value;
means for deducting from the consumer's points account an amount corresponding to the points value of the reward; and
means for providing the consumer with the reward.

26. The system of claim 19, wherein the means for receiving transaction information comprises means for scanning the unrelated coupons and the consumer identifier.
